(19) United States
(12) Patent Application Publication
(10) Pub. No.: US 2015/0189667 A1
(43) Pub. Date: Jul. 2, 2015

(54) METHOD AND APPARATUS FOR PERFORMING INTERFERENCE CANCELLATION

(71) Applicant: LG Electronics Inc., Seoul (KR)

(72) Inventors: Kunil Yum, Seoul (KR); Hyungtae Kim, Seoul (KR); Kijun Kim, Seoul (KR); Jonghyun Park, Seoul (KR); Hanjun Park, Seoul (KR)

(73) Assignee: LG ELECTRONICS INC., Seoul (KR)

(21) Appl. No.: 14/582,281

(22) Filed: Dec. 24, 2014

Related U.S. Application Data
(60) Provisional application No. 61/921,085, filed on Dec. 27, 2013.
(60) Provisional application No. 61/931,672, filed on Jan. 26, 2014.

(51) Int. Cl. H04W 72/08; H04W 4/06; H04W 4/00; H04W 72/04

(52) U.S. Cl. CPC H04W 72/082; H04W 72/042; H04W 4/06; H04W 72/0453; H04W 72/0446; H04W 4/005

(57) ABSTRACT

A method and apparatus for performing interference cancellation are disclosed. A method for performing interference cancellation of a user equipment (UE) includes: receiving interference control information including an index for indicating a subset of one or more interference information elements, the interference control information being scrambled by a specific identifier (ID) which decided a subset configuration of the one or more interference information elements; acquiring a subset of the one or more interference information elements corresponding to the index according to the subset configuration of the one or more interference information elements decided by the specific identifier (ID); and attempting to perform interference cancellation using the subset of the one or more interference information elements.

Pursuant to 35 U.S.C. §119(e), this application claims the benefit of U.S. Provisional Patent Application No. 61/921,085, filed on Dec. 27, 2013, U.S. Provisional Patent Application No. 61/931,672, filed on Jan. 26, 2014, which are hereby incorporated by reference as if fully set forth herein.

### BACKGROUND OF THE INVENTION

1. Field of the Invention

The present invention relates to a wireless access system, and more particularly to a method and apparatus for performing interference cancellation.

2. Discussion of the Related Art

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### SUMMARY OF THE INVENTION

Accordingly, the present invention is directed to a method and apparatus for performing interference cancellation that substantially obviates one or more problems due to limitations and disadvantages of the related art.

An object of the present invention is to provide an interference cancellation method, and a signaling method for more efficiently cancelling interference using the interference cancellation method.

It is to be understood that technical objects to be achieved by the present invention are not limited to the aforementioned technical objects and other technical objects which are not mentioned herein will be apparent from the following description to one of ordinary skill in the art to which the present invention pertains.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for performing interference cancellation of a user equipment (UE) by the user equipment (UE) includes: receiving interference control information including an index for indicating a subset of one or more interference information elements, the interference control information being scrambled by a specific identifier (ID) which decides a subset configuration of the one or more interference information elements; acquiring a subset of the one or more interference information elements corresponding to the index according to the subset configuration of the one or more interference information elements decided by the specific identifier (ID); and attempting to perform interference cancellation using the subset of the one or more interference information elements.

Additionally or alternatively, the subset configuration of the one or more interference information elements may be set in different ways according to frequency bands.

Additionally or alternatively, the method may further include receiving information regarding a valid time of the interference control information.

Additionally or alternatively, the method may further include if additional interference control information is not received within the valid time, attempting to perform interference cancellation using an entire set of the one or more interference information elements.

Additionally or alternatively, the interference control information may be broadcast from a specific base station (BS).

In accordance with another aspect of the present invention, a user equipment (UE) configured to perform interference cancellation includes: a radio frequency (RF) unit; and a processor configured to control the RF unit. The processor may be configured to receive interference control information including an index for indicating a subset of one or more interference information elements, the interference control information being scrambled by a specific identifier (ID) which decides a subset configuration of the one or more interference information elements, acquire a subset of the one or more interference information elements corresponding to the index according to the subset configuration of the one or more interference information elements decided by the specific identifier (ID), and attempt to perform interference cancellation using the subset of the one or more interference information elements.

Additionally or alternatively, the subset configuration of the one or more interference information elements may be set in different ways according to frequency bands.

Additionally or alternatively, the processor may receive information regarding a valid time of the interference control information.

Additionally or alternatively, if additional interference control information is not received within the valid time, the processor may attempt to perform interference cancellation using an entire set of the one or more interference information elements.

Additionally or alternatively, the interference control information may be broadcast from a specific base station (BS).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 exemplarily shows a radio frame structure for use in a wireless communication system.

FIG. 2 exemplarily shows a downlink/uplink (DL/UL) slot structure for use in a wireless communication system.

FIG. 3 exemplarily shows a downlink (DL) subframe structure for use in a 3GPP LTE/LTE-A system.

FIG. 4 exemplarily shows an uplink (UL) subframe for use in a 3GPP LTE/LTE-A system.

FIG. 5 exemplarily shows interference between cells or eNBs (i.e., base stations: BSs) of a wireless communication system according to embodiments of the present invention.

FIG. 6 exemplarily shows interference between cells or eNBs in a wireless communication system from the viewpoint of a frequency band.

FIG. 7 exemplarily shows an example of TPMI transmission for all frequency bands.

FIG. 8 exemplarily shows a transmission period of interference control information according to an embodiment of the present invention.

FIG. 9 exemplarily shows the operations according to an embodiment of the present invention.

FIG. 10 is a block diagram illustrating a device for implementing embodiment(s) of the present invention.

### DESCRIPTION OF SPECIFIC EMBODIMENTS

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g. macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming) DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowlegement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

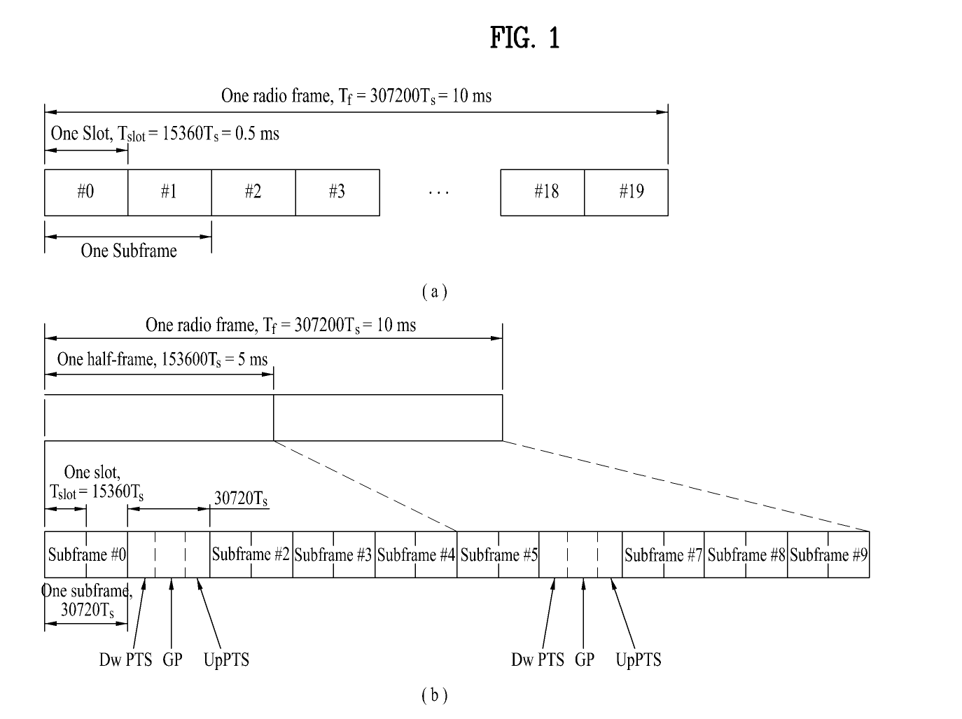

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| | to-Uplink | | | | | | | | | | |
| DL- | Switch- | | | | | | | | | | |
| UL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| | | | Extended | | Normal | Extended |
| Special | | Normal | cyclic | | cyclic | cyclic |
| subframe | | cyclic prefix | prefix in | | prefix in | prefix in |
| configuration | DwPTS | in uplink | uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

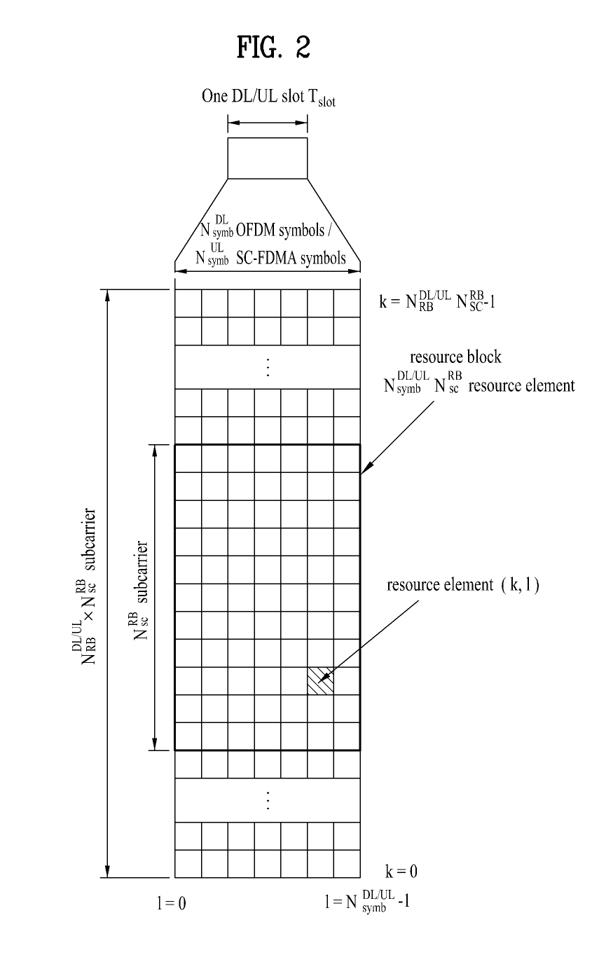

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g. 7) consecutive OFDM symbols in the time domain and N_{sc}^{RB} (e.g. 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, 1) in a slot. Here, k is an index in the range of 0 to N_{symb}^{DL/UL}*N_{sc}^{RB}−1 in the frequency domain and 1 is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, n_{PRB}=n_{VRB} is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

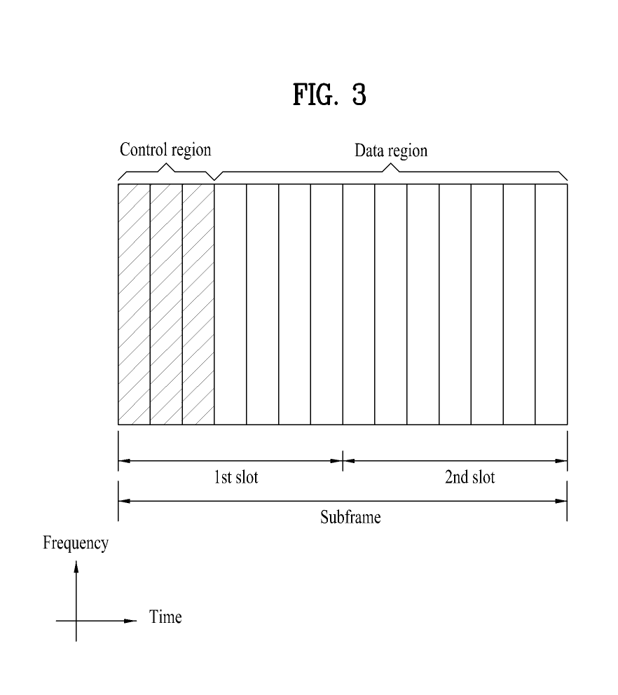

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | |
|---|---|---|---|
| | Aggregation Level | Size | Number of PDCCH |
| Type | L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g. frequency position) of “B” and transmission format information (e.g. transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (HACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One |
| | | | SR + ACK/NACK | codeword |
| 1b | QPSK | 2 | ACK/NACK or | Two |
| | | | SR + ACK/NACK | codeword |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

In an evolved wireless communication system such as LTE Rel-12, a network-based interference cancellation method for cancelling interference data from a neighbor cell or a transmit (Tx) point or a network assisted interference and suppression (NAICS) method is being intensively discussed and studied.

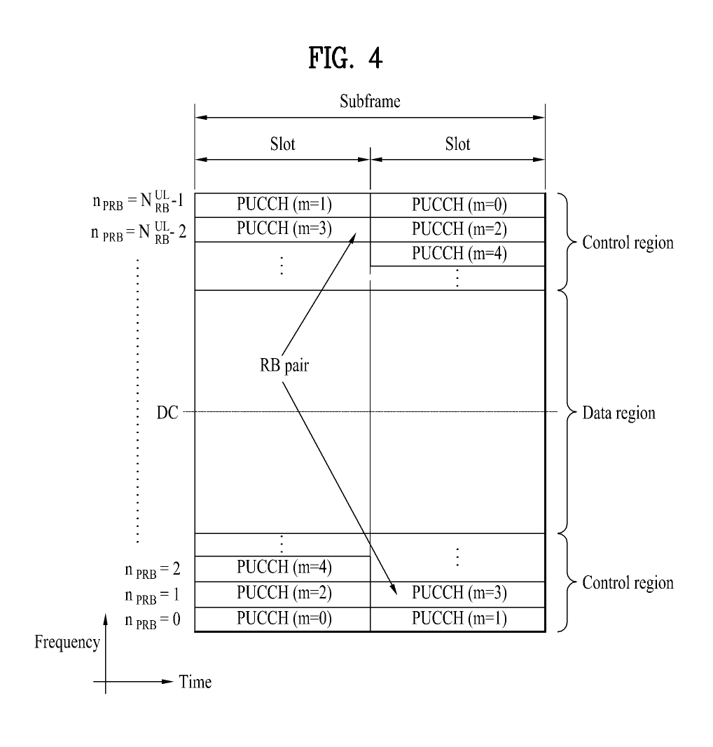

In accordance with the interference environment of FIG. 5, when UE₁ configured to receive a service from eNB₁ and UE₂ configured to receive a service from eNB₂ in the LTE system are present, data transmitted from eNB₁ to UE₁ may affect UE₂ interference and at the same time data transmitted from eNB₂ to UE₂ may affect UE₁ interference. That is, from the viewpoint of UE₁ of FIG. 5, eNB₁ serves as a serving cell, and eNB₂ serves as an interference cell. In FIG. 5, if UE₁ or UE₂ performs the NAIC scheme, demodulation or decoding of contiguous cell data is attempted. Thereafter, if interference data is successfully removed from the received signals, the interference influence can be mitigated. In this case, a UE configured to perform NAICS as well as to have such capability will hereinafter be referred to as “NAICS UE”, and a base station (BS) configured to transmit an interference signal affecting “NAICS UE” will hereinafter be referred to as “interference eNB”.

Interference-associated information capable of assisting NAICS provided from the network to the UE so as to perform the NAICS scheme is present, for example, a transmission mode (TM) of an interference cell, a modulation order, a rank indicator (RI), a TPMI, scheduling information, etc. The above information may be transmitted in various ways to the UE to be NAICS-performed, so that this information may be used to perform NAICS. The information may be transmitted to the UE using a semi-static signal, or may also be transmitted thereto using a dynamic signal. In addition, the interference-associated information may be transferred from the serving cell, or the interference eNB may directly transmit control information of the interference signal.

If a backhaul between eNBs is ideal, the interference-associated information is shared between cells at a very low delay, and then transmitted to the UE to be NAICS-performed. However, in case of a non-ideal backhaul, a minimum of several milliseconds (ms) is consumed for communication between the eNBs, and it is difficult to share information (e.g., TPMI, modulation order, scheduling information, etc.) indicating dynamic characteristics of a channel through a backhaul between the eNBs. In this case, only semi-static information is shared between the eNBs, dynamic information is transmitted by the interference eNB through the assisting PDCCH or the like, so that the UEs may use the dynamic information.

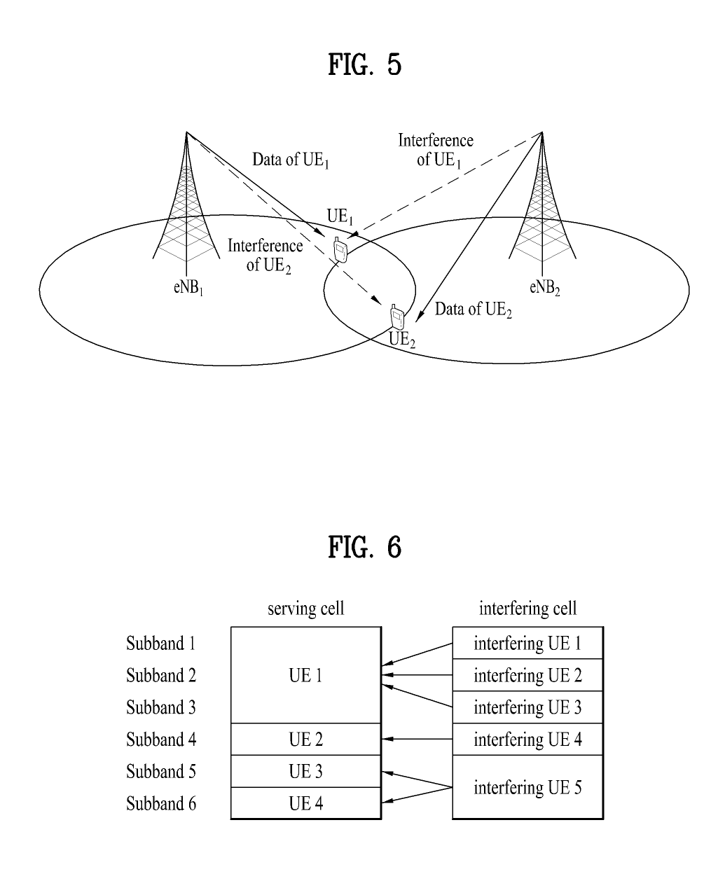

FIG. 6 shows scheduling information per frequency band of the serving eNB and the interference eNB. A subband denoted by “UE 1” may indicate a frequency band obtained by UE 1 scheduling. Referring to FIG. 6, UEs interfered by scheduling of the interference eNB may have different interference information. In FIG. 6, UE 1 is interfered by Subband 4 only, so that only interference information associated with the interference UE 4 is needed. However, UE 1 is scheduled at subbands 1 to 3, so that interference information associated with the interference UE 1, the interference UE 2, and the interference UE 3 is needed.

If the interference eNB desires to transmit interference information needed for UE 1 through a unicast signal, the interference eNB must recognize that the interference information needed for UE 1 is associated with the interference UEs 1 to 3. For this purpose, scheduling information needs to be shared between the eNBs. However, the non-ideal backhaul environment has difficulty in rapidly sharing the scheduling information, so that it is difficult for the interference eNB to recognize not only UEs requiring interference information but also interference information needed for the corresponding UE. Therefore, the interference eNB does not directly transmit interference information to a UE requiring the interference information through a unicast message, and may broadcast the entire interference information.

When broadcasting the interference information, all of the interference information (for example, all of the scheduling information of the interference UEs 1 to 5) must also be contained in the broadcast interference information. Although a detailed operation of the present invention will hereinafter be disclosed on the basis of LTE, the above operations can also be applied to arbitrary wireless communication systems configured to transmit interference information for a UE desired to perform NAICS during the transmission process of control information.

The interference eNB may broadcast TPMI information for UEs. If an interference signal at a specific band unit (e.g., subband) scheduled for UEs is based on TM4, the interference eNB may broadcast TPMI information used at the specific band unit. TPMI acting as a precoding vector adapted for a continuously fluctuating channel has dynamic characteristics, such that it is difficult for necessary information to be applied to the UE through a non-ideal backhaul. Preferably, TPMI may be broadcast from the interference eNB in association with a band unit configured to use TM4. The UE may estimate an effective interference channel using interference channel information estimated through the received TPMI and CRS, and may use the estimated effective interference channel for a subsequent NAICS process.

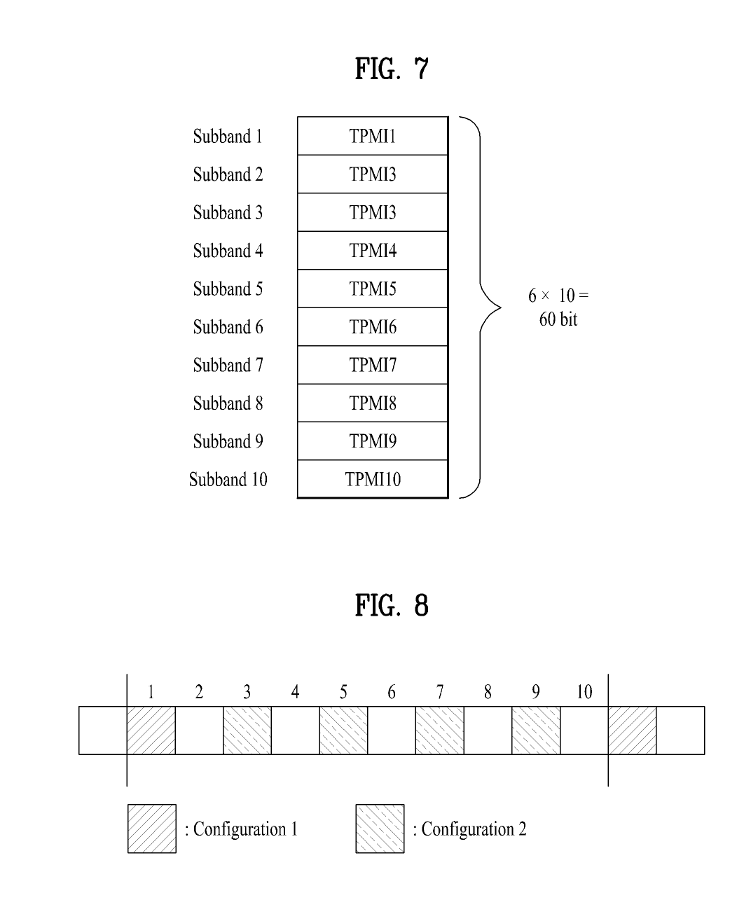

However, from the viewpoint of the interference eNB, broadcasting interference information per unit of the entire band may encounter unexpected load in terms of payload. FIG. 7 shows an example of broadcasting per-unit TPMI information on the basis of a subband. For example, if the number of Tx antennas of the interference eNB is set to 4, the number of bits needed to transmit a single 1-rank TPMI is 6. If this information is transmitted at each of a total of 10 subbands as shown in FIG. 7, payload corresponding to a total of 60 bits may be needed. If the eNB does not provide payload having the corresponding size or larger for various reasons, the interference eNB may not transmit all or some of necessary information.

Therefore, if the UE is capable of detecting TPMI through blind detection (BD), the corresponding information may be semi-statically signaled or predefined through radio resource control (RRC) or the like, instead of transmission of all TPMIs. After transmission of indexes of TPMI subsets known to both a UE from which interference will be removed and the interference eNB, BD is performed in the corresponding subset, so that a necessary TPMI can be found. In this case, the interference eNB uses the TPMI subset index configured to use a smaller number of bits than the entire TPMI index, so that payload can be reduced. The UE may prevent necessary information from being completely lost, and perform BD in a smaller number of candidate groups, resulting in an increased BD success rate.

The subset of such interference information may be predefined, and a new subset (i.e., the subset capable of performing BD between candidates in the corresponding subset) capable of improving BD performance may be defined and used.

An example of a Rank-1 disjoint codebook subset capable of reducing 2 bits (i.e., reduction of 1 bit) under 4Tx situation is as follows.

TABLE 5

Subset index

| | 0 | 1 | 2 | 3 |
|---|---|---|---|---|
| 2 bit | u₀, u₂, | u₁₂, u₁₃, | u₁, u₃, | u₄, u₇, |
| reduced | u₈, u₁₀ | u₁₄, u₁₅ | u₉, u₁₁ | u₅, u₆ |
| subset | | | | |

u₀˜u₁₅ may be based on an LTE 4Tx codebook. That is, the LTE 4Tx codebook is denoted by index of 4 bits, so that 4 bits are needed to indicate the codebook index per specific band unit. However, if the subset of the codebook is limited as described above, 2 bits are needed to indicate the codebook subset index. In the above-mentioned example, constituent elements contained in the subset are orthogonal to each other (i.e., disjoint subset).

The following table 6 shows an example of reducing 1 bit (i.e., 1-bit reduction) in consideration of a Frobenius distance between codewords for use in the 4Tx 2-Rank codebook.

TABLE 6

| | Subset index | | | | | | | |
|---|---|---|---|---|---|---|---|---|
| | 0 | 1 | 2 | 3 | 4 | 5 | 6 | 7 |
| 1 bit | u₀, | u₁, u₃ | u₄, u₁₄ | u₅, u₁₃ | u₆, u₈ | u₇, u₉ | u₁₀, u₁₂ | u₁₁, u₁₅ |
| reduced | u₂ | | | | | | | |
| subset | | | | | | | | |

In Table 6, 8 subset indexes are present, and 3 bits are needed to indicate the subset index, so that 1 bit is reduced.

The subsets can be classified by methods other than the above-mentioned example. For example, the subsets may be classified on the basis of another reference (e.g., a distance between covariance matrices of the codeword), and may also be classified without using the disjoint scheme within the entire information in a manner that some information may overlap with each other within the subsets. Alternatively, subsets may also be constructed with the exception of some codewords. In addition, not only the codebook index but also other interference information may be used to reduce the number of bits in a similar way to the above-mentioned scheme.

In order to allow the UE to interpret interference information transmitted from the eNB, it is necessary to recognize whether transmitted information has been used to reduce the number of bits. If the corresponding interference information is sufficiently changed over the long term, signaling information communicated between the eNBs through a backhaul may indicate which one of the schemes will be applied to transmission of current interference information.

On the other hand, if interference information is dynamically changed, it may be difficult to indicate the corresponding information through the backhaul. In this case, various types of group RNTIs may be defined and used. When interference information to be broadcast is masked, RNTI is used, and the UE may confirm integrity of specific information having been transmitted using the RNTI. Therefore, various steps depending on the bit reduction degrees may be used. If different group RNTIs are used in individual steps, the UE may select a group RNTI having integrity, that is CRC-checked from among candidates of the group RNTI aggregate, such that the UE can determine which one of steps includes the corresponding information associated with bit reduction.

Table 7 shows an example of interference information configuration. In accordance with the exemplary interference information configuration shown in Table 7, two kinds of interference information (i.e., TPMI and a modulation order) may be established, and the reduction degree of each interference information is classified into two steps (i.e., “no reduction” and “1-bit reduction”). In Table 7, different group RNTIs may be applied to individual interference information configurations. In the case of the modulation order, 2 bits are needed to indicate three legacy modulation orders (QPSK, 16QAM, 64QAM). In order to reduce 1 bit, after the modulation order is classified into two groups (e.g., {QPSK, 64QAM} and {16QAM}), group indexes can be transmitted.

TABLE 7

Reduction Degree

| Group RNTI | TPMI | Modulation Order |
|---|---|---|
| Group RNTI 1 | No reduction | No reduction |
| Group RNTI 2 | 1 bit reduction | 1 bit reduction |

In this case, the above-mentioned table does not exclude an exemplary case in which information based on the overall band may be reduced by a predetermined number of bits. That is, bit reduction may be achieved in different ways according to individual band units. For example, as can be seen from FIG. 6, UE 1 may perform BD in a subset that is maximally reduced by 1 bit, UE 2 may perform BD in a subset that is maximally reduced by 2 bits, and UE 3 may perform BD in a subset that is maximally reduced by 1 bit. In this case, interference information configuration can be achieved as shown in the following Tables 8 and 9.

TABLE 8

| | Reduction Degree | | | |
|---|---|---|---|---|
| Group RNTI | TPMI | | Modulation Order | |
| number | Subband 1-4 | Subband 5-6 | Subband 1-4 | Subband 5-6 |
| Group RNTI 1 | No reduction | No reduction | No reduction | No reduction |
| Group RNTI 2 | 2 bit | 1 bit | 1 reduction | 1 bit |
| | reduction | reduction | | reduction |

TABLE 9

| | Reduction Degree | | | |
|---|---|---|---|---|
| Group RNTI | TPMI | | Modulation Order | |
| number | Subband 1-4 | Subband 5-6 | Subband 1-4 | Subband 5-6 |
| Group RNTI 1 | No reduction | No reduction | No reduction | No reduction |
| Group RNTI 2 | 1 bit | No reduction | 1 bit | No reduction |
| | reduction | | reduction | |
| Group RNTI 3 | 1 bit | 1 bit | 1 bit | 1 bit |
| | reduction | reduction | reduction | reduction |
| Group RNTI 4 | 2 bit | 1 bit | 1 bit | 1 bit |
| | reduction | reduction | reduction | reduction |

The UE desired to cancel interference may have a different BD capability for the same information according to various situations. For example, if the UE can perform TPMI BD based on 1-bit reduction on the condition that a rank of the interference signal is set to 1, BD of TPMI may be performed in only one of two layers, or may not be performed in both of two layers. Therefore, when the interference configuration information based on bit reduction is designed, the above-mentioned situation must be considered. In Table 10, 1-bit reduced TPMI BD can be achieved at RI=1, and interference information configuration capable of being applied to a UE having no BD capability of TPMI at RI=2 can be achieved.

TABLE 10

| | Group RNTI | Reduction Degree |
|---|---|---|
| RI | number | TPMI |
| 1 | Group RNTI 1 | No reduction |
| | Group RNTI 2 | 1 bit reduction |
| 2 | Group RNTI 1 | No reduction |
| | Group RNTI 2 | No reduction |

The scheme for applying different group RNTIs to different interference information configurations can be applied not only to one case in which the same payload size is achieved but also to the other case in which different payload sizes are achieved.

Assuming that different lengths are achieved among different interference information configurations, although the same group RNTI is used between one interference information configuration from which bits are not reduced in number and the other interference information configuration from which bits are reduced in number as shown in the following Table 11, the UE can discriminate the corresponding information through BD. However, the UE must recognize a length candidate of interference information to be interpreted.

TABLE 11

| | |
|---|---|
| Group RNTI | Reduction Degree |

| number | TPMI | Modulation Order |
|---|---|---|
| Group RNTI 1 | No reduction | No reduction |
| Group RNTI 1 | 1 bit reduction | 1 bit reduction |

In another example, if the payload size of interference information configuration from which bits are not reduced in number is identical to the payload size of interference information configuration from which bits are reduced in number, a flag composed of n bits may be inserted or different configurations may be distinguished using specific interference information as a flag. For example, if two interference information configurations having the same payload size are present as shown in the following Table 12, the flag of 1 bit is inserted so that “flag bit=0” and “flag bit=1” can be distinguished from each other under the same group RNTI.

TABLE 12

| | |
|---|---|
| Group RNTI | Reduction Degree |

| number | TPMI | Modulation Order |
|---|---|---|
| Group RNTI | 2 bit reduction | No reduction |
| 1, Flag bit = | | |
| 0 | | |
| Group RNTI | 1 bit reduction | 1 bit reduction |
| 1, Flag bit = | | |
| 1 | | |

In addition, the eNB or UE must define a set of the above interference information configuration, so that the set of interference information configuration must be shared between the eNBs. Constituent elements of the interference information configuration may be RNTI allocation information, flag allocation information, and the type, length, position, and total length of interference information. Various types of dynamic interference information for NAICS may be used, for example, TM, TPMI (if CRS-based TM), RI (if DMRS-based TM), modulation order, Pa, etc. For example, Table 13 shows a total length and a length of payload needed for three kinds of interference information (i.e., TM, TPMI, and a modulation order). Table 13 shows an exemplary case in which the same-length payload is applied to all subbands. If a total length of payload is identical as shown in Table 13, two configurations are distinguished from each other using different RNTIs (i.e., Group RNTI 1 and Group RNTI 2).

TABLE 13

| Assigned | | | | |
|---|---|---|---|---|
| Group RNTI | | | Modulation | |
| number | TM | TPMI(RI) | Order | Total Length |
| Group RNTI 1 | 1 bit | 6 bits | 2 bits | 15 bits |
| Group RNTI 1 | 1 bit | 5 bits | 1 bit | 12 bits |
| Group RNTI 2 | 1 bit | 4 bits | 2 bits | 12 bits |
| Group RNTI 1 | 1 bit | 4 bits | 1 bit | 11 bits |

If there are a large number of interference information configuration types, the UE may have difficulty in performing BD between interference information configurations. Therefore, a total number of interference information configurations may be limited to a specific number (e.g., 4).

In addition, the operation for broadcasting interference information configuration by the interference eNB according to the present invention may be intermittently transmitted at intervals of a predetermined time. For example, the interference eNB may broadcast the corresponding information on the basis of an offset corresponding to m subframes at intervals of a predetermined time corresponding to n subframes according to the predefined ‘n’ and ‘m’ values. The period (n) and the offset (m) may be defined in different ways with respect to two or more interference information configurations.

FIG. 8 exemplarily shows a transmission period of two interference information configurations on a subframe basis. In FIG. 8, Configuration 1 may illustrate the case of n=10 and m=0, and Configuration 2 may illustrate the case of n=2 and m=0. In FIG. 8, the case in which, if Configuration 1 and Configuration 2 overlap with each other, Configuration 2 is dropped. The drop priority between configurations may be shared in advance in the same manner as in RRC.

In addition, the above-mentioned interference information configuration may be aperiodically transmitted in the above period/offset frame. That is, if the interference eNB need not update interference information at a specific time, interference information of the corresponding time point may not be broadcast as necessary. In this case, the UE may use the latest Tx interference information configuration from among a plurality of interference information configurations generated before the corresponding time.

When the interference information configuration is shared, the above interference information configuration may include all or some of interference information sets contained in the interference information configuration. While the interference eNB performs scheduling, it may be impossible to guarantee an interference information configuration lifetime corresponding to a predetermined transmission (Tx) period. For example, since there is an insufficient amount of resources to be used for the eNB configured to perform broadcasting, the interference information set may not be transmitted at intervals of a predetermined time required for the UE. In this case, the UE may decide the NAICS scheme on the basis of the above-mentioned guarantee time. The UE may use the above interference information during the guarantee time contained in the corresponding interference information configuration. Thereafter, until reaching the next update process, the UE may perform BD within a non-limited set, or may perform the NAICS that does not use the above interference information.

In accordance with the above-mentioned embodiment, during cooperation in terms of a network for NAICS UE, the above-mentioned embodiment can also be applied to the case in which the interference eNB limits specific resources in short term, differently from the long-term limitation based on legacy RRC. For example, for network cooperation, the eNB may limit a TPMI to be used at a specific subband to constituent elements of a specific set. In this case, configuration information of the predefined interference information set is signaled to the serving eNB through RRC signaling, and the interference eNB may indicate the TPMI limitation set to be used by the interference eNB through broadcasting.

Although the above-mentioned example has exemplarily disclosed that interference information is broadcast in the interference cell, the present invention can also be applied to arbitrary transmission schemes in which control information is dynamically transmitted through radio resources.

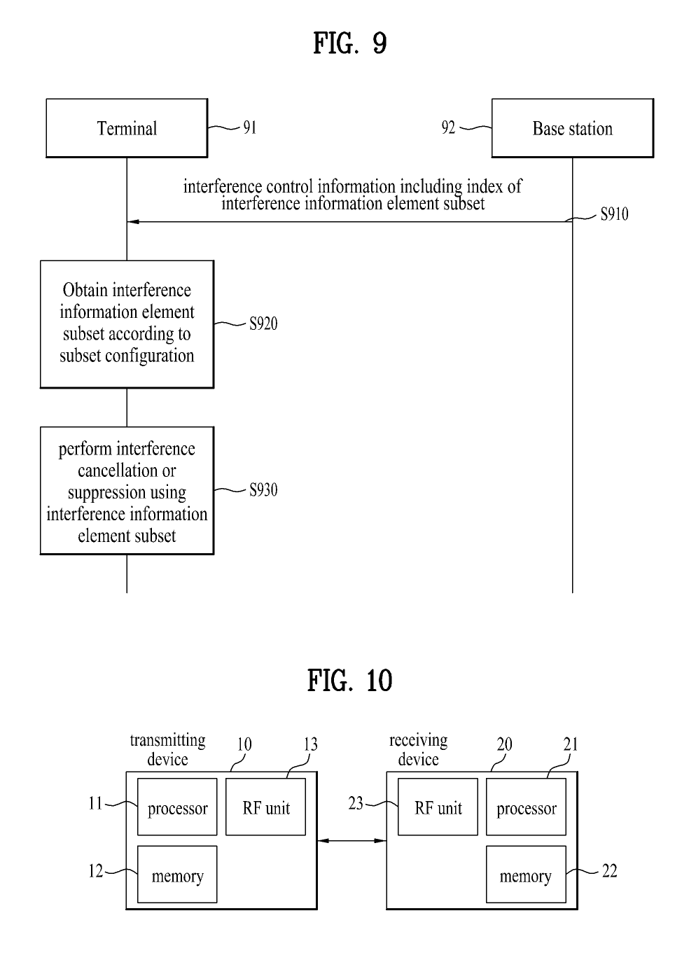

FIG. 9 exemplarily shows the operations of the embodiments.

Referring to FIG. 9, a terminal (i.e., a UE) 91 may receive interference control information including indexes indicating a subset of one or more interference information elements from a base station (BS) 92 in step S910. The interference control information may be control information associated with the interference signal, and may include one or more interference information elements. For example, the interference information elements may correspond to TPMI, RI, modulation order, or transmission (Tx) mode, etc. The interference control information is scrambled with a specific identifier (ID), and the specific ID may determine a subset configuration of the one or more interference information elements. That is, the specific ID may correspond to a subset configuration of at least one interference information element, so that the terminal (UE) receiving the interference control information may decide the specific ID through CRC checking of the interference control information, and may recognize a subset configuration corresponding to the specific ID. The subset configuration may correspond to information shown in Tables 7 to 13.

In more detail, the specific ID may be the above-mentioned group RNTI, and the terminal must recognize the set of group RNTI candidates in advance. In addition, the subset configuration must be provided to the terminal in advance through semi-static signaling or through a promise related to the eNB. That is, the terminal may attempt to detect the interference control information using group RNTIs contained in the candidate set of the group RNTIs, and may recognize a subset configuration corresponding to each group RNTI having been successfully detected (i.e., CRC-checked).

The terminal (UE) may obtain a subset of the one or more interference information elements corresponding to the index according to the subset configuration of the one or more interference information elements decided by the specific ID in step S920. If the subset configuration is recognized, the terminal may recognize the index of one or more interference information elements of the interference control information. That is, as shown in the subset configuration of Table 13, assuming that a specific ID having successfully detected the interference control information is denoted by Group RNTI 1 and a total length of the interference control information is 12 bits, the terminal may recognize that the subset configuration associated with the interference control information is composed of TM, TPMI(RI), and a modulation order, and their indexes are denoted by 1 bit, 5 bits, and 1 bit, respectively, so that the terminal can recognize the indexes of TM, TPMI(RI) and the modulation order. If the interference information element is denoted by TPMI and a total set of TPMI is denoted by 6 bits, this means that the subset configuration includes a subset index of 1-bit reduced TPMI so that the terminal can recognize a TPMI subset indicated by the subset index of TPMI.

The terminal may attempt to cancel interference using the subset of the one or more interference information elements in step S930. The terminal has already obtained information regarding the subset instead of a total set of each interference information element in step S920, so that the terminal may attempt to cancel or suppress interference within a smaller range.

In addition, subset configuration s of the one or more interference information elements may be established in different ways according to respective frequency bands.

In addition, the terminal may receive information regarding a valid time of the interference control information. If additional interference control information is not received within the valid time, the terminal may attempt to cancel interference using a total set of the one or more interference information elements.

In addition, the interference control information may be broadcast from a specific eNB.

FIG. 10 is a block diagram of a transmitting device 10 and a receiving device 20 configured to implement exemplary embodiments of the present invention. Referring to FIG. 10, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

In embodiments of the present invention, a UE serves as the transmission device 10 on uplink and as the receiving device 20 on downlink. In embodiments of the present invention, an eNB serves as the receiving device 20 on uplink and as the transmission device 10 on downlink.

The transmitting device and/or the receiving device may be configured as a combination of one or more embodiments of the present invention.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may use each construction described in the above embodiments in combination with each other. Accordingly, the invention should not be limited to the specific embodiments described herein, but should be accorded the broadest scope consistent with the principles and novel features disclosed herein.

The present invention may be used for a wireless communication apparatus such as a user equipment (UE), a relay and an eNB.

As is apparent from the above description, the embodiments of the present invention can efficiently perform interference cancellation through interference cancellation information, and can achieve efficient signaling for interference cancellation.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for performing interference cancellation by a user equipment (UE), comprising:
receiving interference control information including an index for indicating a subset of one or more interference information elements, the interference control information being scrambled by a specific identifier (ID) which decides a subset configuration of the one or more interference information elements;
acquiring a subset of the one or more interference information elements corresponding to the index according to the subset configuration of the one or more interference information elements decided by the specific identifier (ID); and
attempting to perform interference cancellation using the subset of the one or more interference information elements.

2. The method according to claim 1, wherein the subset configuration of the one or more interference information elements is set in different ways according to frequency bands.

3. The method according to claim 1, further comprising:
receiving information regarding a valid time of the interference control information.

4. The method according to claim 3, further comprising:
if additional interference control information is not received within the valid time, attempting to perform interference cancellation using an entire set of the one or more interference information elements.

5. The method according to claim 1, wherein the interference control information is broadcast from a specific base station (BS).

6. A user equipment (UE) device configured to perform interference cancellation, comprising:
a radio frequency (RF) unit; and
a processor configured to control the RF unit,
wherein the processor is configured to receive interference control information including an index for indicating a subset of one or more interference information elements, the interference control information being scrambled by a specific identifier (ID) which decides a subset configuration of the one or more interference information elements, acquire a subset of the one or more interference information elements corresponding to the index according to the subset configuration of the one or more interference information elements decided by the specific identifier (ID), and attempt to perform interference cancellation using the subset of the one or more interference information elements.

7. The user equipment (UE) device according to claim 6, wherein the subset configuration of the one or more interference information elements is set in different ways according to frequency bands.

8. The user equipment (UE) device according to claim 6, wherein the processor receives information regarding a valid time of the interference control information.

9. The user equipment (UE) device according to claim 8, wherein:
if additional interference control information is not received within the valid time, the processor attempts to perform interference cancellation using an entire set of the one or more interference information elements.

10. The user equipment (UE) device according to claim 6, wherein the interference control information is broadcast from a specific base station (BS).
